(19) United States
(12) Patent Application Publication
(10) Pub. No.: US 2011/0128882 A1
(43) Pub. Date: Jun. 2, 2011

(54) RADIO TRANSMITTER AND RADIO RECEIVER

(75) Inventors: Noriyuki Shimizu, Kanagawa (JP); Yuta Seki, Kanagawa (JP)

(73) Assignee: Panasonic Corporation, Osaka (JP)

(21) Appl. No.: 13/055,446

(22) PCT Filed: Aug. 27, 2009
(86) PCT No.: PCT/JP2009/004176

§ 371 Date: Jan. 21, 2011

(30) Foreign Application Priority Data
Sep. 1, 2008 (JP) 2008223718

(51) Int. Cl. H04L 12/26

(52) U.S. Cl. 370/252

(57) ABSTRACT

A radio transmitter and a radio receiver which reduce the number of blind determinations of control signals while maintaining resource utilization efficiency. A radio transmitter (100) includes a hash value calculating section (131) for calculating a hash value from a bit sequence indicating the device ID of each device or a transmission destination, and arranges a plurality of control channel signals in the order in which the calculated hash value of the each device increases or decreases monotonously in a frequency region which is the mapping resource range of the control channel signals. A radio receiver (200) acquires the order in which the control channel signals arranged according to the hash value are arranged. Even when the terminal ID included in the control channel signal decoded first is not the terminal ID of the radio receiver (200), the radio receiver (200) predicts the range in which the control channel signal including the terminal ID of the radio receiver (200) exists in the order by comparing the hash values obtained from both the terminal IDs with each other.

### TECHNICAL FIELD

The present invention relates to a radio transmitting apparatus and a radio receiving apparatus.

### BACKGROUND ART

The 3GPP LTE adopts OFDMA (Orthogonal Frequency Division Multiple Access) as a communication scheme on a downlink. A downlink data signal is transmitted through a downlink shared channel (PDSCH: Physical Downlink Shared Channel). A downlink control signal necessary to receive this PDSCH is transmitted through a downlink control channel (PDCCH: Physical Downlink Control Channel). That is, since PDCCH is a channel that reports control information, PDCCH includes downlink resource block assignment information (downlink RB assignment information), hybrid ARQ information (Hybrid Automatic Repeat request information) or the like.

PDCCH is transmitted to a transmission target terminal (transmission target UE) for a downlink data signal determined by a scheduler of a base station. Scheduling of downlink data signal transmission is performed in subframe units. Therefore, PDCCH is transmitted in each subframe.

A terminal is not aware of whether or not downlink control signal and downlink data signal are transmitted to that terminal in each subframe. Therefore, the terminal needs to make a blind decision on PDCCH for each subframe. When a PDCCH decoding result of a certain subframe includes the terminal ID of that terminal, the terminal determines that this PDCCH is directed to that terminal and also determines that a downlink data signal directed to the terminal is transmitted in this subframe. In this case, the terminal demodulates and decodes the downlink data signal directed to that terminal using control information transmitted through that PDCCH.

Here, in order to demodulate and decode PDCCH by a blind decision as described above, the terminal needs to demodulate and decode PDCCH in all subframes even when there is no PDSCH directed to that terminal. The number of times PDCCH is demodulated and decoded (which may be hereinafter referred to as “blind decision count”) is determined by a signal bandwidth, PDCCH control information length and the number of OFDM symbols to which PDCCH is mapped. Depending on the condition, the blind decision count may reach or exceed 100, which may constitute a large burden on the terminal.

Thus, Non-Patent Literature 1 proposes to limit a location (frequency, time) at which PDCCH is arranged for each terminal, and limit the range in which the terminal makes blind decisions. FIG. 1 shows positions at which PDCCHs are arranged according to Non-Patent Literature 1. In FIG. 1, CCE (Control Channel Element) is a minimum unit region to which PDCCH is mapped. Furthermore, as shown in FIG. 1, the mapping area of PDCCH is divided into a plurality of regions. Each terminal is associated with one of divided regions (which may be hereinafter referred to as “search space”). Search spaces 0 to 3 are provided in FIG. 1. The terminal knows the search space to which the terminal is assigned in advance, and makes a blind decision only for the search space of the terminal. By so doing, the blind decision count of the terminal can be reduced. That is, since the mapping area of PDCCH is divided into four equal parts in FIG. 1, the blind decision count is reduced to ¼.

### CITATION LIST

### Patent Literature

NPL 1
3GPP RANI R1-073373

### SUMMARY OF INVENTION

### Technical Problem

However, since the above described prior art assigns search spaces to each terminal quasi-fixedly, when scheduling is concentrated on a terminal group associated with one search space in a certain subframe, there is a problem that downlink control signals cannot be transmitted to some terminals, resulting in deterioration of the system throughput and service compensation rate. Furthermore, there is another problem that there are areas where downlink control signals are not mapped in other search spaces, resulting in deterioration of resource utilization efficiency.

It is an object of the present invention to provide a radio transmitting apparatus and a radio receiving apparatus that reduce a blind decision count of control signals while maintaining resource utilization efficiency.

### Solution to Problem

The radio transmitting apparatus of the present invention is a radio transmitting apparatus that maps a plurality of control channel signals for different transmission target apparatuses, to a frequency domain assigned to a control channel, and transmits the control channel signals and adopts a configuration including a calculation section that calculates a hash value from a bit sequence representing an apparatus ID of each transmission target apparatus and a mapping section that arranges the plurality of control channel signals in the frequency domain in a sequence in which the calculated hash value of the each transmission target apparatus monotonously increase or decreases.

The radio receiving apparatus of the present invention is a radio receiving apparatus that receives a plurality of control channel signals transmitted from the above described radio transmitting apparatus and searches for a control channel signal directed to the radio receiving apparatus from among the plurality of received control channel signals and adopts a configuration including a storage section that stores the plurality of received control channel signals, a decoding section that decodes the control channel signals outputted from the storage section, an ID comparing section that compares the apparatus ID included in the decoded control channel signal with the apparatus ID of the receiving apparatus; a calculation section that calculates, when the apparatus ID and the apparatus ID of the receiving apparatus are different, hash values from the apparatus ID and th apparatus ID of the receiving apparatus respectively and a control section that compares the hash values calculated in the calculation section and outputs a sequence of control channel signals according to the comparison results to the storage section.

### Advantageous Effects of Invention

According to the present invention, it is possible to provide a radio transmitting apparatus and a radio receiving apparatus capable of reducing a blind decision count of control signals while maintaining source utilization efficiency.

### BRIEF DESCRIPTION OF DRAWINGS

FIG. 1 is a diagram illustrating conventional positions at which PDCCHs are arranged;

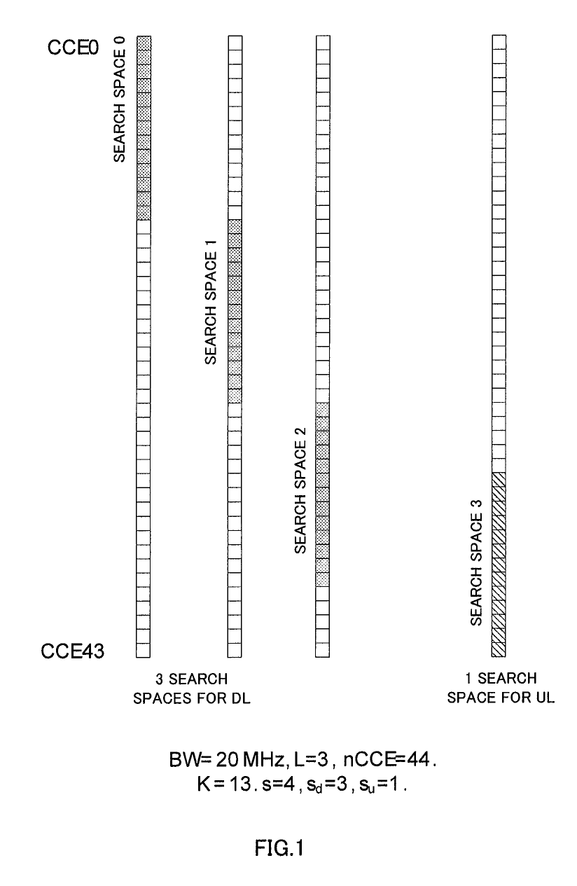

FIG. 2 is a block diagram illustrating a configuration of a radio transmitting apparatus according to an embodiment of the present invention;

FIG. 3 is a block diagram illustrating a configuration of a transmission signal forming section;

FIG. 4 is a block diagram illustrating a configuration of a radio receiving apparatus according to the embodiment of the present invention;

FIG. 5 is a block diagram illustrating a configuration of a decoding section;

FIG. 6 is a diagram illustrating operations of the radio transmitting apparatus and radio receiving apparatus; and

FIG. 7 is a flowchart related to search processing on the terminal ID of the radio receiving apparatus.

### DESCRIPTION OF EMBODIMENTS

Hereinafter, an embodiment of the present invention will be described in detail with reference to the accompanying drawings.

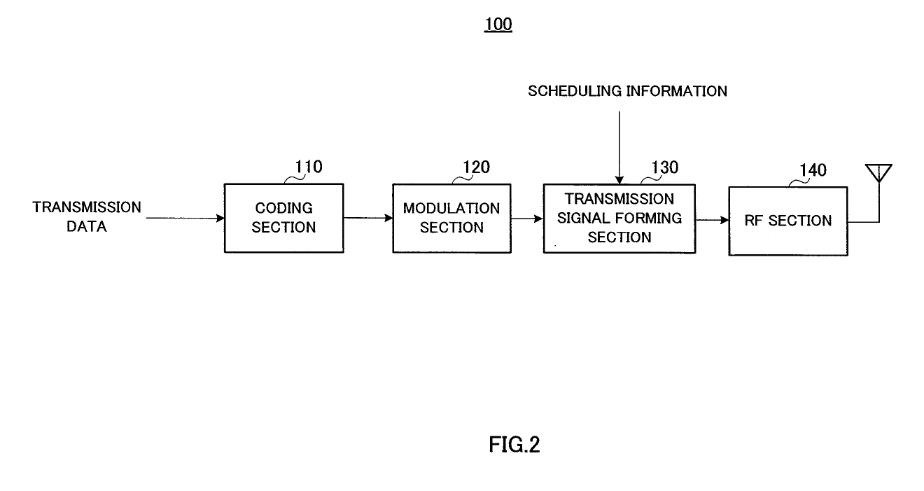

FIG. 2 is a block diagram illustrating a configuration of a radio transmitting apparatus according to the present embodiment. In FIG. 2, radio transmitting apparatus 100 includes coding section 110, modulation section 120, transmission signal forming section 130 and RF section 140. Radio transmitting apparatus 100 is a base station (BS).

Coding section 110 receives transmission data as input and codes the input transmission data. To be more specific, coding section 110 codes the input transmission data with an error correction code such as convolutional code, repeats or punctures the data sequence obtained and thereby adjusts the data sequence to a predetermined transmission rate. Furthermore, coding section 110 interleaves the data sequence whose transmission rate has been adjusted and adds a CRC code to the data sequence obtained. The transmission data coded by coding section 110 is inputted to modulation section 120.

Modulation section 120 receives the coded transmission data as input and modulates the input transmission data according to a predetermined modulation scheme (e.g., QPSK).

Transmission signal forming section 130 receives the modulated signal and scheduling information as input and forms a transmission signal corresponding to the scheduling information from the modulated signal. The scheduling information includes terminal IDs of all scheduling target terminals selected by a scheduler (not shown) and transmission timing or the like.

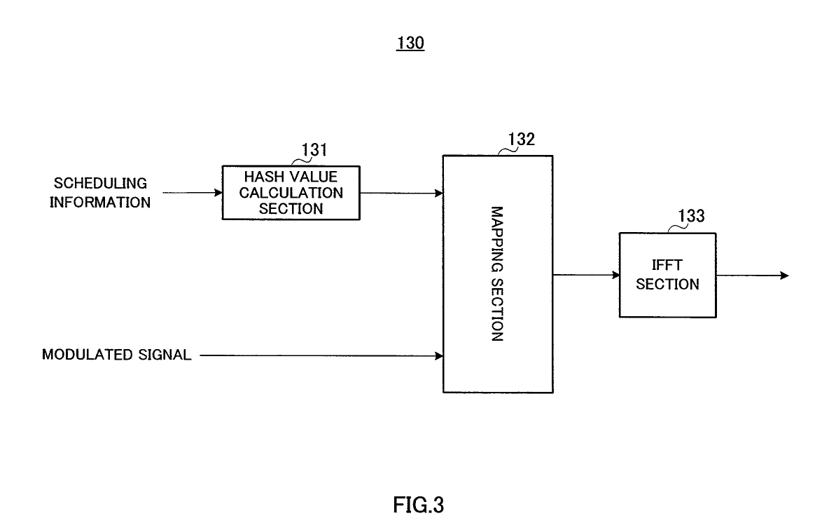

FIG. 3 is a block diagram illustrating a configuration of transmission signal forming section 130. In FIG. 3, transmission signal forming section 130 includes hash value calculation section 131, mapping section 132 and IFFT section 133.

Hash value calculation section 131 calculates a hash value from a bit sequence representing a terminal ID of each scheduling target terminal included in the scheduling information.

Mapping section 132 performs the following mapping processing on a modulated signal of a control channel. Mapping section 132 arranges and maps a plurality of control channel signals in a control channel mapping region in a sequence in which calculated hash values of the scheduling target terminal monotonously increase or decrease. For example, mapping section 132 arranges the plurality of control channel signals in this frequency domain so that the calculated hash values monotonously increase from the low frequency side to the high frequency side.

A group of control channel signals to a plurality of scheduling target terminals having the same hash value may be arranged in a sequence based on downlink quality information fed back from each terminal to radio transmitting apparatus 100.

IFFT section 133 transforms frequency domain signals mapped to a plurality of subcarriers by mapping section 132 into a time domain signal. An OFDM signal formed as described above is outputted to RF section 140.

Returning to FIG. 2, RF section 140 applies radio transmission processing (digital analog conversion, up-conversion or the like) to the OFDM signal formed in transmission signal forming section 130 and transmits the radio signal obtained via an antenna.

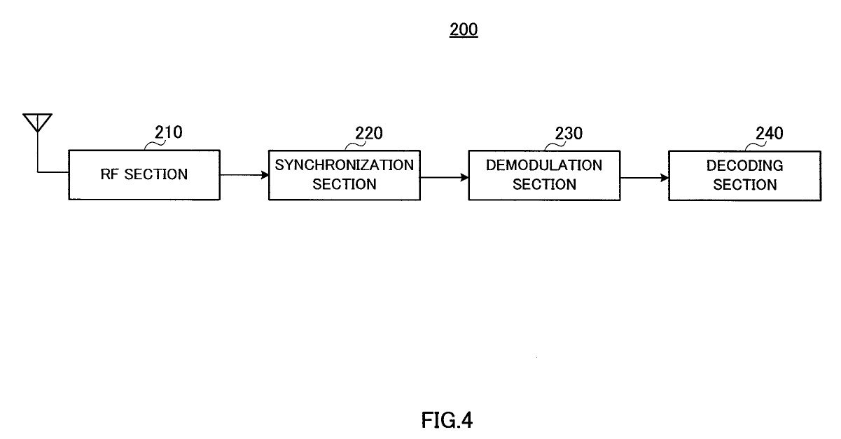

FIG. 4 is a block diagram illustrating a configuration of a radio receiving apparatus according to the present embodiment. In FIG. 4, radio receiving apparatus 200 includes RF section 210, synchronization section 220, demodulation section 230 and decoding section 240. Radio receiving apparatus 200 is a terminal (UE).

RF section 210 applies reception radio processing (down-conversion, analog digital conversion or the like) to a radio signal received via an antenna and inputs the received signal obtained to synchronization section 220.

Synchronization section 220 performs synchronization processing (time and frequency synchronization processing) based on a synchronization sequence included in the received signal.

Demodulation section 230 demodulates the received signal and outputs the demodulated received signal to decoding section 240. That is, demodulation section 230 outputs a candidate group of control channel signals directed to radio receiving apparatus 200 to decoding section 240.

Decoding section 240 searches for control channel signals directed to radio receiving apparatus 200 and repeats decoding processing until the corresponding control channel signal is found. Furthermore, decoding section 240 limits control channel signals to be decoded based on hash values calculated from the terminal ID obtained from the decoding result this time and the terminal ID of radio receiving apparatus 200 respectively, and performs the next decoding processing.

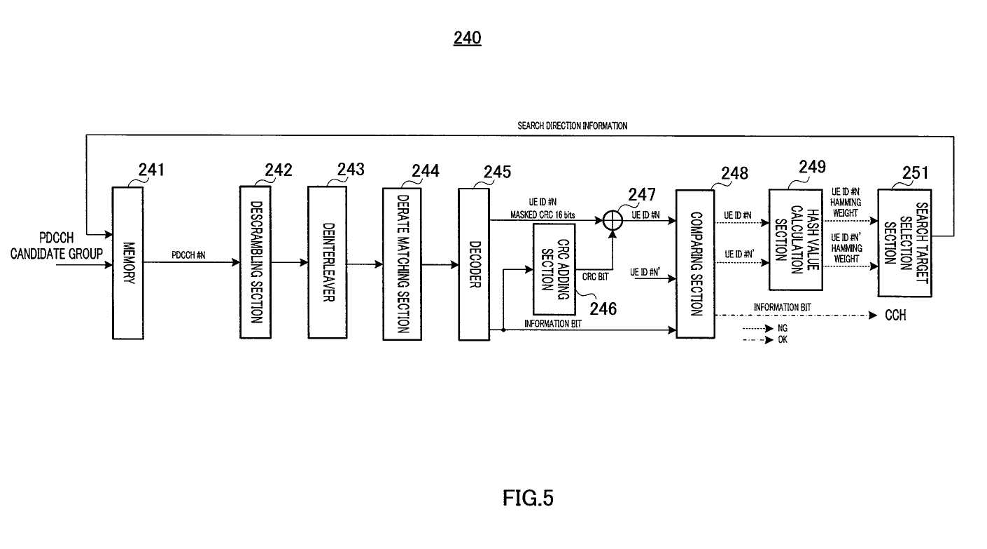

FIG. 5 is a block diagram illustrating a configuration of decoding section 240. In FIG. 5, decoding section 240 includes memory 241, descrambling section 242, deinterleaver 243, derate matching section 244, decoder 245, CRC adding section 246, adder 247, comparing section 248, hash value calculation section 249 and search target selection section 251.

Memory 241 selects an output control channel signal based on search direction information received from search target selection section 251 and outputs the selected control channel signal to the subsequent stage. A control channel signal first outputted from the control channel signal group transmitted in one transmission section is predetermined and is a control channel signal which is in the center of the sequence, for example.

The control channel signal outputted from memory 241 is descrambled by descrambling section 242, deinterleaved by deinterleaver 243, derate matched by derate matching section 244 and decoded by decoder 245.

CRC adding section 246 performs CRC coding on the decoding result obtained by decoder 245.

Adder 247 adds the bit sequence obtained in CRC adding section 246 to the decoding result obtained by decoder 245. An exclusive OR between the CRC bit masked with a terminal ID included in the decoding result obtained by decoder 245 and the CRC bit obtained by CRC adding section 246 is calculated and an unmasked terminal ID is thereby obtained.

Comparing section 248 compares the terminal ID included in the decoding target control channel signal this time obtained in adder 247 with the terminal ID of radio receiving apparatus 200.

When the comparison result shows that both IDs match, comparing section 248 judges that the control channel signal directed to radio receiving apparatus 200 has been found and outputs the decoding result obtained by decoder 245. On the other hand, when the comparison result shows that both IDs do not match, comparing section 248 outputs the terminal ID included in the decoding target control channel signal this time and the terminal ID of radio receiving apparatus 200.

Hash value calculation section 249 calculates hash values from the terminal ID included in the decoding target control channel signal this time and the terminal ID of radio receiving apparatus 200 respectively. Here, Hamming weights are used as hash values. A “Hamming weight” is the number of non-zero bits in a bit sequence. For example, in the case of bit sequence 0111011, the Hamming weight is 5.

Search target selection section 251 compares both hash values obtained by hash value calculation section 249 and generates search direction information corresponding to the comparison result. The search direction information includes, for example, an instruction for outputting control channel signals within a range of the sequential order close to the decoding target control channel signal this time or an instruction for outputting control channel signals within a range other than that range of smaller or greater sequential order. That is, search target selection section 251 limits the range of subsequent decoding target control channel signals to one of the above described three ranges according to the comparison result of hash values calculated from the terminal ID included in the first decoding target control channel signal and the terminal ID of radio receiving apparatus 200, respectively.

Next, operations of radio transmitting apparatus 100 and radio receiving apparatus 200 having the above described configurations will be described.

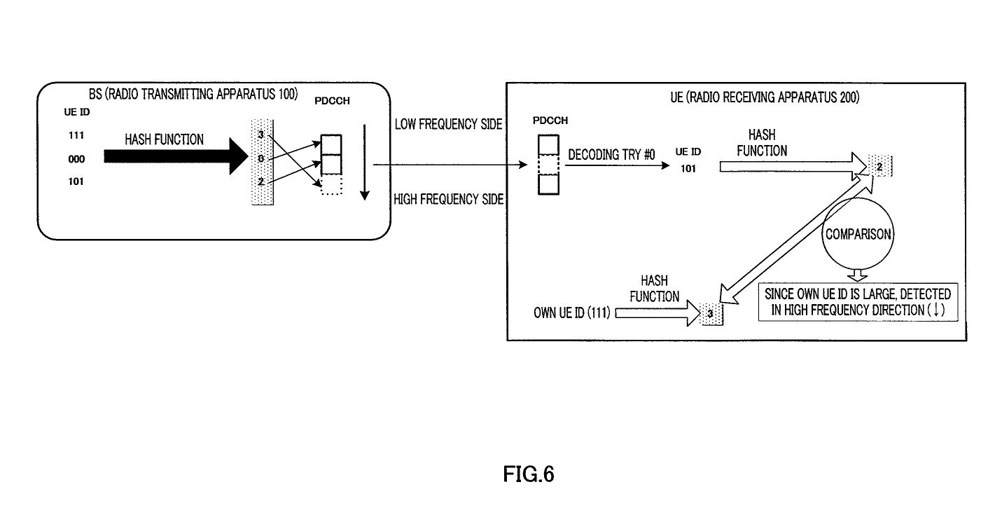

FIG. 6 is a diagram illustrating operations of radio transmitting apparatus 100 and radio receiving apparatus 200.

As shown in FIG. 6, radio transmitting apparatus 100 calculates a hash value from a bit sequence representing a terminal ID of each scheduling target terminal included in scheduling information. A plurality of control channel signals to be transmitted to a scheduling target terminal are arranged and mapped in a mapping region of control channels in a sequence in which the calculated hash values of the scheduling target terminal monotonously increase or decrease. In FIG. 6, the control channel signal is shown as a PDCCH signal. Furthermore, in FIG. 6, one block represents CCE. That is, in FIG. 6, a plurality of control channel signals are arranged so that the calculated hash values monotonously increase from the low frequency side to the high frequency side.

The control channel signals mapped in this way are transformed into an OFDM signal and then transmitted to radio receiving apparatus 200.

The OFDM signal transmitted from radio transmitting apparatus 100 is received by radio receiving apparatus 200. Radio receiving apparatus 200 stores a control channel signal group transmitted in one transmission section in memory 241. The control channel signal in the center of the sequence of the control channel signal group arranged on the transmitting side (PDCCH corresponding to UE ID 101 in FIG. 6) is outputted from memory 241 first.

The terminal ID extracted from the control channel signal outputted from memory 241 is compared with the terminal ID of radio receiving apparatus 200.

When both terminal IDs do not match, hash values are calculated from both terminal IDs. Search target selection section 251 then compares the two calculated hash values, limits a search target control channel signal of the terminal ID of radio receiving apparatus 200 based on the comparison result and outputs an output instruction of a control channel signal within the limited range to memory 241.

In FIG. 6, the hash value calculated from the terminal ID of radio receiving apparatus 200 is 3 and the hash value calculated from UE ID 101 is 2. Therefore, search target selection section 251 outputs an instruction for outputting control channel signals within a range of permutation of the control channel signal group arranged based on the hash values corresponding to hash values greater than 2 to memory 241. That is, search target selection section 251 limits the output target control channel signals to control channel signals mapped to a higher frequency side than the control channel signal corresponding to UE ID 101.

As described so far, since search target control channel signals of the terminal ID of radio receiving apparatus 200 are limited based on the comparison result between the terminal IDs extracted from control channel signals outputted from memory 241 and the terminal ID of radio receiving apparatus 200, the blind decision count of control channel signals is reduced.

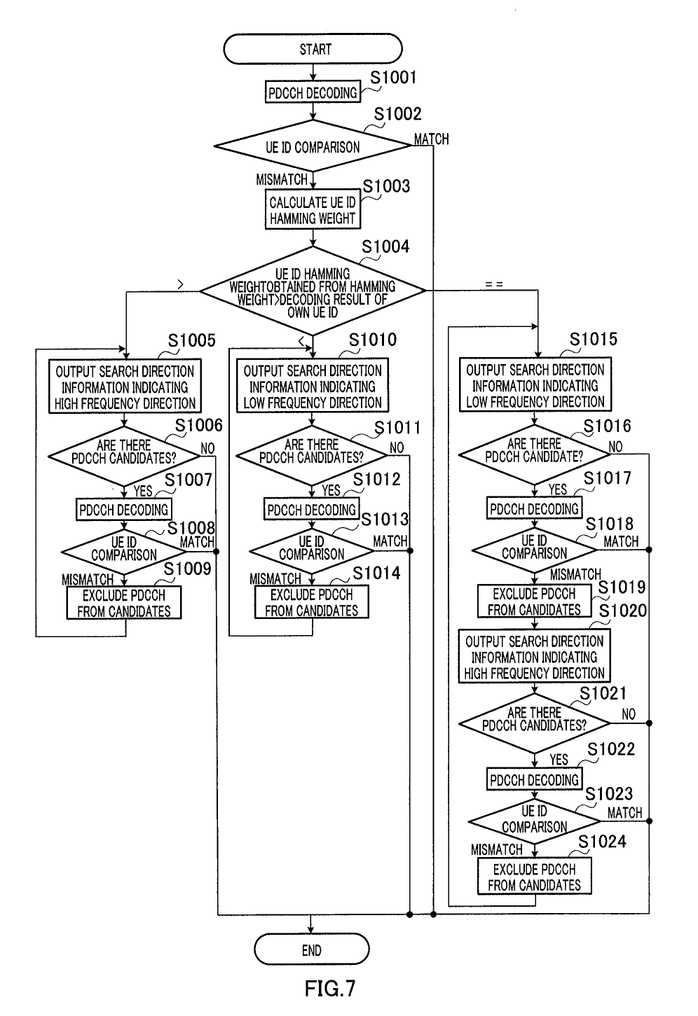

FIG. 7 is a flowchart related to search processing on the terminal ID in radio receiving apparatus 200.

In step S1001, decoder 245 decodes a control channel signal first outputted from memory 241 among a control channel signal group transmitted in one transmission section.

In step S1002, comparing section 248 compares the terminal ID included in the decoding target control channel signal this time obtained by adder 247 with the terminal ID of radio receiving apparatus 200 and judges whether or not both terminal IDs match.

The comparison result shows that both IDs match, comparing section 248 judges that a control channel signal directed to radio receiving apparatus 200 has been found and outputs the decoding result obtained by decoder 245.

On the other hand, when both IDs do not match, in step S1003, hash value calculation section 249 calculates hash values (here, Hamming weights) from the terminal ID included in the decoding target control channel signal this time and the terminal ID of radio receiving apparatus 200 respectively.

In step S1004, search target selection section 251 compares both hash values obtained by hash value calculation section 249.

Search target selection section 251 generates search direction information corresponding to this comparison result and outputs the search direction information to memory 241.

To be more specific, when the comparison result in step S1004 shows that the terminal ID of radio receiving apparatus 200 is greater than the terminal ID included in the decoding target control channel signal this time, in step S1005, search target selection section 251 outputs search direction information indicating the high frequency direction (that is, an instruction for outputting control channel signals mapped to a higher frequency side than the control channel signal corresponding to the terminal ID decoded this time). This causes subsequent decoding target ranges to be limited to a range of a control channel signal group mapped to the high frequency side and transmitted (that is, a high frequency side range).

Upon receiving search direction information indicating the high frequency direction, in step S1006, memory 241 outputs a control channel signal included in the above described high frequency side range. The control channel signal outputted in this way is passed from descrambling section 242 through decoder 245 and subjected to PDCCH decoding (step S1007). When no such control channel signal to be outputted exists, the decoding processing ends.

In step S1008, comparing section 248 compares the terminal ID included in the decoding target control channel signal this time obtained by adder 247 with the terminal ID of radio receiving apparatus 200 and judges whether or not both terminal IDs match.

When the comparison result shows that both IDs match, comparing section 248 judges that the control channel signal directed to radio receiving apparatus 200 has been found, and outputs the decoding result obtained by decoder 245.

On the other hand, when both IDs do not match, in step S1009, search target selection section 251 removes the decoding target control channel signal this time from subsequent decoding target candidates and outputs, in step S1005, search direction information for instructing memory 241 to output a decoding target control channel signal included in the high frequency side range.

Furthermore, the comparison result in step S1004 shows that the terminal ID of radio receiving apparatus 200 is smaller than the terminal ID included in the decoding target control channel signal this time, processing from step S1010 to step S1014 is performed. This processing is similar to the processing from step S1005 to step S1009 except in that the subsequent decoding target range is limited to a low frequency side range.

Furthermore, the comparison result in step S1004 shows that the terminal ID of radio receiving apparatus 200 is identical to the terminal ID included in the decoding target control channel signal this time, processing from step S1015 to step S1024 is performed. This processing is substantially the same as the processing in step S1005 to step S1009 except in that subsequent decoding target ranges are limited to the central frequency range.

As described so far, according to the present embodiment, in radio transmitting apparatus 100, hash value calculation section 131 calculates a hash value from a bit sequence representing an apparatus ID of each transmission target apparatus and arranges a plurality of control channel signals in a frequency domain which is a mapping resources range of control channel signals in a sequence in which the calculated hash value of each transmission target apparatus monotonously increases or decreases.

By so doing, the receiving side can acquire a permutation formed by a control channel signal group arranged using hash values as a reference. Thus, even when the terminal ID included in a first decoded control channel signal does not match the receiving terminal's ID, it is possible to predict the range in which control channel signals including the receiving terminal's ID exist in the above described permutation by comparing hash values calculated from both terminal IDs. Therefore, since the processing range is limited in subsequent decoding processing (that is, blind decision processing), the blind decision count can be reduced.

Furthermore, unlike the above described prior art, mapping positions of control channel signals are not fixed with respect to each terminal. That is, since control channel signals can be equally mapped over the entire mapping resource region, it is possible to prevent utilization efficiency of resources from deteriorating and prevent the system throughput and service compensation rate from deteriorating.

Furthermore, according to the present embodiment, in radio receiving apparatus 200, comparing section 248 compares the apparatus ID included in a decoded control channel signal with the apparatus ID of radio receiving apparatus 200, hash value calculation section 249 calculates, when the apparatus ID is different from the apparatus ID of radio receiving apparatus 200, hash values from the apparatus ID and the apparatus ID of radio receiving apparatus 200, search target selection section 251 compares the hash values calculated by hash value calculation section 249 and outputs control channel signals in a sequence corresponding to the comparison result to memory 241.

Although Hamming weights of terminal IDs have been used as hash values above, the present invention is not limited to this, but a Hamming distance of the terminal ID or a decimal converted value of a bit sequence representing a terminal ID may also be used.

The disclosure of Japanese Patent Application No. 2008-223718, filed on Sep. 1, 2008, including the specification, drawings and abstract is incorporated herein by reference in its entirety.

### INDUSTRIAL APPLICABILITY

The radio transmitting apparatus and the radio receiving apparatus of the present invention are useful as apparatuses capable of reducing a blind decision count of control signals while maintaining resource utilization efficiency.

1. A radio transmitting apparatus that maps a plurality of control channel signals for different transmission target apparatuses, to a frequency domain assigned to a control channel, and transmits the control channel signals, comprising:
a calculation section that calculates a hash value from a bit sequence representing an apparatus ID of each transmission target apparatus; and
a mapping section that arranges the plurality of control channel signals in the frequency domain in a sequence in which the calculated hash value of the each transmission target apparatus monotonously increases or decreases.

2. The radio transmitting apparatus according to claim 1, wherein the calculation section calculates a Hamming weight of the bit sequence as the hash value.

3. The radio transmitting apparatus according to claim 1, wherein the calculation section calculates a Hamming distance of the bit sequence as the hash value.

4. The radio transmitting apparatus according to claim 1, wherein the calculation section calculates a decimal converted value of the bit sequence as the hash value.

5. A radio receiving apparatus that receives a plurality of control channel signals transmitted from the radio transmitting apparatus according to claim 1 and searches for a control channel signal directed to the radio receiving apparatus from among the plurality of received control channel signals, comprising:
a storage section that stores the plurality of received control channel signals;
a decoding section that decodes the control channel signals outputted from the storage section;
an ID comparing section that compares the apparatus ID included in the decoded control channel signal with an ID of the receiving apparatus;
a calculation section that calculates, when the apparatus ID and the ID of the receiving apparatus are different, hash values from the apparatus ID and the ID of the receiving apparatus respectively; and
a control section that compares the hash values calculated in the calculation section and outputs a sequence of control channel signals according to the comparison results to the storage section.

6. The radio receiving apparatus according to claim 5, wherein the control section selects one of a control channel signal group whose sequential order is close to a control channel signal in which the apparatus ID is included, a control channel signal group whose sequential order is before that of the control channel signal group and a control channel signal group whose sequential order is after that of the control channel signal group based on the comparison result and outputs only control channel signals included in the selected signal group to the storage section.
